(19) United States
(12) Patent Application Publication
(10) Pub. No.: US 2017/0021458 A1
(43) Pub. Date: Jan. 26, 2017

(54) CUTTING AN END OFF A THIN-WALLED HOLLOW BODY

(71) Applicant: H&T MARSBERG GMBH & CO. KG, Marsberg (Bredelar) (DE)

(72) Inventors: Volker SEEFELDT, Marsberg (DE); Tobias GOETTE, Marsberg (DE)

(21) Appl. No.: 15/025,267

(22) PCT Filed: Jun. 24, 2014
(86) PCT No.: PCT/EP2014/001704

§ 371 Date: Mar. 26, 2016

(30) Foreign Application Priority Data
Apr. 15, 2014 (DE) 10 2014 005 562.0

(51) Int. Cl. B23K 26/38; B23K 26/40; B23K 26/08

(52) U.S. Cl. CPC B23K 26/38; B23K 26/0823; B23K 26/40; B23K 2201/125

(57) ABSTRACT

The invention relates to a method for separating off an annular edge portion (2) from a cylindrical, thin-walled hollow article (1), in particular a deep-drawn, cup-shaped hollow article (1), the cylindrical hollow article (1) being turned about its cylinder axis (4) and a laser beam being directed onto the cutting point during the multiple turns until the edge portion (2) is detached from the rest of the hollow article.

The invention relates to a method and apparatus for separating an annular end portion of a cylindrical, thin-walled, tubular workpiece, in particular a deep-drawn, cup-shaped tubular workpiece.

In the production of deep-drawn, cup-shaped tubular workpieces made of metal, the edge surrounding the cup opening is always uneven and/or has a troublesome flange, such that the edge has to be separated. For this purpose, the known approach is that of mechanically cutting off the annular end portion using various methods of shear cutting.

The problem addressed by the invention is that of providing a method and an apparatus for separating an annular end portion of a cylindrical, thin-walled, metal tubular workpiece, that produces a smooth, clean cut edge at high volume.

This problem is addressed according to the invention in that the cylindrical tubular workpiece is rotated about its cylindrical axis, and during the multiple rotations thereof, a laser beam is directed at a cut zone until the end portion is separated from the rest of the tubular workpiece.

In the method according to the invention, the laser beam does not cut through the tubular workpiece wall in only one rotation. Rather, metal is removed over the course of multiple rotations, such that initially only an annular groove is formed in the metal, and this groove becomes deeper with each repeated rotation until the annular end portion is separated. In this case, a very high rotational speed is selected, such that a shorter cutting time is achieved than with the known method. For example, at 10,000 rotations per minute, the annular end portion is separated after only 5 to 7 rotations, and accordingly after about 50 milliseconds, thereby achieving a high volume. In this way, a very clean and smooth cut edge is achieved.

Optimum results are achieved if:
the metallic, cylindrical tubular workpiece has an inner diameter of 5 to 100 mm, preferably from 7 to 70 mm, and a wall thickness of 0.05 to 1.0 mm, and preferably of 0.1 to 0.5 mm,
the tubular workpiece is made to rotate during the laser cutting at 1000 to 20,000, and preferably 5000 to 10,000, rotations per minute,
the tubular workpiece wall is cut and separated after 3 to 10, and preferably 5 to 7, rotations of the tubular workpiece.

In this case, the cylindrical tubular workpiece is a deep-drawn cup made of steel, aluminum, or brass. The cylindrical tubular workpiece is preferably a battery can, a cartridge casing, a metal packaging, pressure vessel, or a beverage container.

With the method according to the invention, it is possible to impart different shapes to the cut edge. For this purpose, the laser beam is mounted by a suitable device to be able to move relative to the axis of the tubular cylindrical workpiece such that it can be oriented with respect to the axis of the tubular workpiece. The orientation of the laser beam with respect to the separation point can be modified in this case for the processing of the cut edge of the tubular cylinder.

It is particularly advantageous if, during separation, a tubular mandrel, and in particular a nozzle, projects into the tubular workpiece, in particular coaxially to the tubular workpiece axis, and a gas, in particular air, is blown through it into the interior of the tubular workpiece in order to convey metal particles removed by the laser beam, and/or the melt, out from inside the tubular workpiece. In this way, it is also possible for the tubular workpiece to be pressed against a fixed limit stop by the gas/air, at least during the separating process, by its end facing away from the cutting site—in particular the base of the cup—in order to precisely position of the tubular workpiece.

A further advantage of the gas or air stream is that the separated annular end portion is conveyed away. Thus, the separated annular end portion is conveyed by the gas or air stream onto the tubular mandrel, in particular the nozzle, to then be subsequently removed therefrom.

It is preferably suggested that a camera is directed at the cutting site for the purpose of monitoring.

A very fast and safe operation is achieved if, during rotation, the tubular workpiece is supported on wheels or rollers, the side of the tubular workpiece opposite the wheels or rollers being engaged by at least one drive wheel or roller that bears against the outer surface of the tubular workpiece to rotate it about its axis.

An apparatus used to carry out the above method has a turret wheel with a step drive and multiple seats that each receive a respective one of the tubular workpieces to be processed, and that the seats can be moved through a work station where a laser and a drive wheel or a drive roller are used to rotate and cut the tubular workpiece.

Embodiments of the invention are shown schematically in the drawings and are described in more detail below. In the drawings:

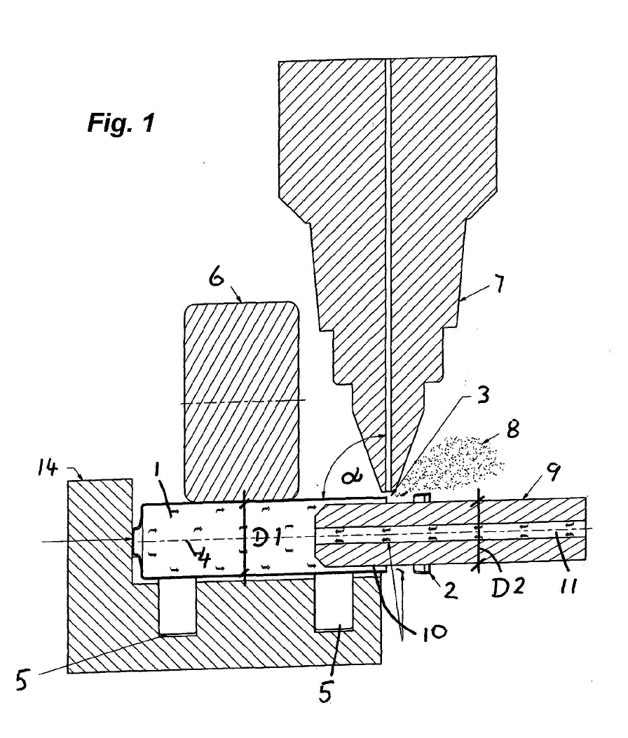

FIG. 1 is an axial section through a tubular workpiece inside a laser-cutting apparatus after the end portion has been separated;

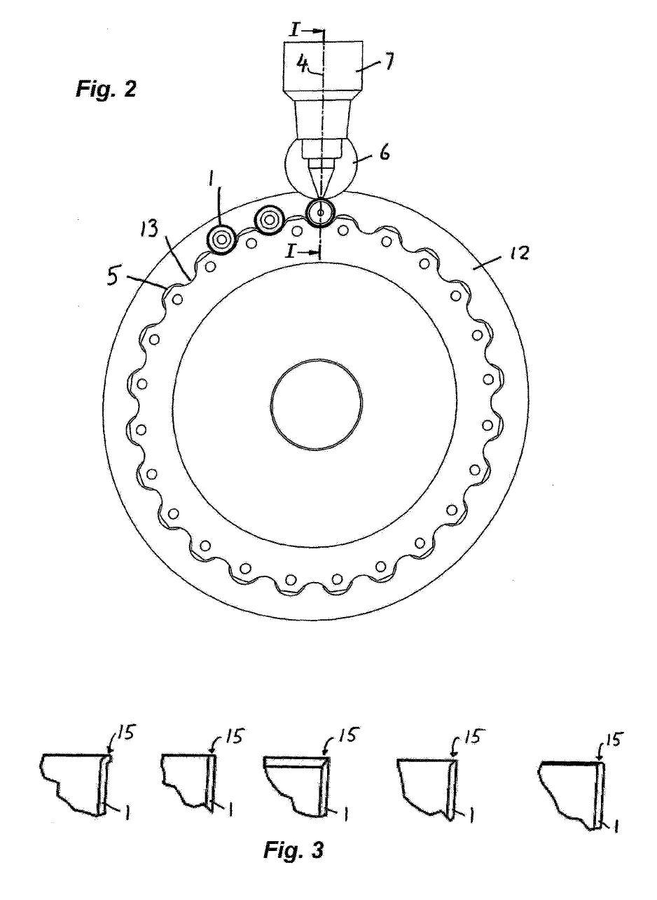

FIG. 2 is a view of a turret or carousel disk having a plurality of seats for receiving tubular workpieces and having an upper work station;

FIG. 3 are sections of differently shaped cut edges of the tubular workpiece after the end portion has been removed.

In order to separate an annular end portion 2 at one end of a metallic, cylindrical, and tubular workpiece 1, a laser beam 3 is directed at the cylindrical outer surface (jacket) of the tubular workpiece, particularly radially, while the tubular workpiece 1 in this case is rotated about its axis 4 such that this axis is also the axis of rotation. In this case, the tubular workpiece 1 rotates about its axis at such a high rotation speed that an severing and separation of the tubular workpiece wall is not achieved with only one rotation. Instead, the metal is removed over the course of several rotations, such that initially only an annular groove is formed in the metal, and this groove becomes deeper with each following rotation until the annular end portion is separated. In this case, a very high rotational speed is selected, such that a short cutting time is achieved for the complete separation. At 5000 to 10,000 rotations per minute, the end portion 2 is completely separated from the tubular workpiece 1 after only 5 to 7 rotations.

The tubular workpiece 1 is a cylindrical tube or a deep-drawn cup made of steel, aluminum, or brass. The method can be used in a particularly advantageous manner for battery cans, cartridge casings, metal packaging, pressure vessels, and beverage cans. In this case, the metallic, cylindrical tubular workpiece has an inner diameter of 5 to 100 mm, preferably from 7 to 70 mm, and a wall thickness of 0.05 to 1.0 mm, preferably from 0.1 to 0.5 mm. The rotation speed can preferably range between 1000 and 20,000 revolutions per minute.

FIG. 1 schematically illustrates an apparatus for separating an annular end portion 2 of a cylindrical, thin-walled tubular workpiece 1 here in the form of a cup. The tubular workpiece 1 is supported by wheels or rollers 5 whose axes are parallel to the axis 4. Opposite the wheels or rollers, the outer surface of the tubular workpiece is engaged by at least one drive wheel or roller 6 in order to rotate it about its axis at a high speed. In this case, a laser emitter 7 and its laser beam 3 are directed at the cutting site to remove metal particles 8 during each rotation. Once the wall of the tubular workpiece is cut and separated, the end portion 2 is removed from the tubular workpiece.

In FIG. 1, the laser emitter, and therefore the laser beam 3, are directed at an angle α of 90° to the outer surface (JACKET surface) of the tubular workpiece 1. However, to process the cutting site of the tubular workpiece, in a further embodiment the laser emitter 7 and its laser beam 3 are pivoted in order to achieve certain shapes of the cutting site 15 as shown in FIG. 3.

This processing of the cutting site is carried out during and/or after cutting.

The separation method according to the invention can be carried out in a particularly advantageous manner if, as shown in FIG. 1, a mandrel (nozzle) 9 is engaged coaxially inside the tubular workpiece 1 during the cutting process, and the cylindrical outer surface of the mandrel has an outer diameter D2 that is slightly smaller than an inner diameter D1 of the tubular workpiece such that a coaxial annular gap 10 is created between the outer surface of the mandrel and the inner surface of the tubular workpiece 1. A gas—in particular compressed air—is pumped into the interior of the tubular workpiece 1 through the longitudinal passage 11 of the mandrel 9 (or nozzle). This achieves several advantages. First, metal particles removed by the laser beam, and/or the melt, are conveyed out of the interior of the tubular workpiece by this pumped-in gas passing outward through the annular gap 10. Second, cooling occurs. In addition, the tubular workpiece is pressed against a fixed limit stop 14 by this gas, at least during the separating process, by its end that is remote from the cutting site—in particular the base of the cup—in order to precisely position of the tubular workpiece 1 during the cutting. Also, the end portion 2 is carried away by the gas stream immediately after its separation, and in particular is slid onto the tubular mandrel as shown in FIG. 1.

A very fast supply of tubular workpieces 1 to the workstation is achieved if the turret wheel or disk 12 is used that has a large number of seats 13 that each receive a respective tubular workpiece 1. Once a tubular workpiece 1 has reached the workstation with the laser emitter 7, the tubular workpiece 1 is rotated by the drive wheel 6 about its axis, while each seat 13 is located between two or more overlapping wheels 5 on the turret wheel or the carousel disk 12 in a manner allowing rotation.

A camera is directed toward the cutting site, to monitor the cutting. This camera is not illustrated in the drawings.

1. A method for separating an annular end portion of a cylindrical, thin-walled tubular workpiece, the method comprising the steps of:
rotating the cylindrical tubular workpiece about its axis, and,
during multiple rotations of the workpiece, directing a laser beam at a cutting site until the end portion is separated from the rest of the tubular workpiece.

2. The method according to claim 1, wherein the metallic, cylindrical tubular workpiece has an internal diameter of 5 to 100 mm and a wall thickness of 0.05 to 1.0 mm.

3. The method according to claim 1, wherein the tubular workpiece is rotated during the laser cutting at 1000 to 20,000 rotations per minute.

4. The method according to claim 1, wherein the tubular workpiece wall is cut and separated after 3 to 10 rotations of the tubular workpiece.

5. The method according to claim 1, wherein the cylindrical tubular workpiece is a deep-drawn cup made of steel, aluminum or brass.

6. The method according to claim 5, wherein the cylindrical tubular workpiece is a battery can, a cartridge case, a metallic packaging, a pressure vessel, or a beverage container.

7. The method according to claim 1, wherein, to process the cutting site of the tubular workpiece, the laser beam is aimed obliquely to the axis of the tubular workpiece.

8. The method according to claim 1, wherein, to process the cutting site of the tubular workpiece, the orientation of the laser beam with respect to the cutting site can be varied.

9. The method according to claim 1, further comprising the step of:
during rotation of the workpiece, engaging a tubular nozzle into the tubular workpiece particular coaxially to the tubular workpiece axis, and
blowing a gas through the nozzle into the interior of the tubular workpiece in order to convey metal particles removed by the laser beam out of the tubular workpiece interior.

10. The method according to claim 9, further comprising the step of:
pressing the tubular workpiece against a fixed limit stop by the gas/air at least during the separating process by its closed workpiece end that is remote from the cutting site in order to precisely position of the tubular workpiece.

11. The method according to claim 9, further comprising the step of:
conveying the separated annular end portion away by the gas stream.

12. The method according to claim 11, wherein the separated annular end portion is conveyed away by being displaced by the gas or air stream onto the tubular nozzle, to then be subsequently removed therefrom it.

13. The method according to claim 1, further comprising the step of:
monitoring the cutting with a camera is directed toward the cutting site.

14. The method according to claim 1, further comprising the step of:
supporting the tubular workpiece by wheels or rollers, and
engaging the side of the tubular workpiece opposite the wheels or rollers by at least one rotating drive wheel or roller bearing against the outer surface of the tubular workpiece to rotate it about its axis.

15. The method defined in claim 1, further comprising the steps of:
supporting the workpiece during rotation and cutting in a seat of a turret wheel or carousel disk having multiple seats each for receiving a respective one of the tubular workpieces to be processed, and
rotating the wheel or disk such that the seats move d through a work station where a laser emitter and a drive wheel or a drive roller are provided, and where each workpiece is rotated during cutting.

16. A method of cutting end portions off tubular workpieces centered on respective workpiece axes, the method comprising the steps of:
fitting each of the workpieces to a radially outwardly open seat of a wheel having a plurality of the seats spaced angularly about a wheel center axis with each of the workpieces engaging a respective pair of idler rollers on the wheel so as to be oriented with the respective workpiece axis parallel to the wheel center axis;
angularly rotationally stepping the wheel such that each of the workpieces is passed through and stopped for a predetermined time in a work station fixed with respect to the wheel;
pressing each workpiece when stopped in the work station against the respective rollers and simultaneously rotating the workpiece about its axis; and
directing a laser beam at each workpiece when stopped in the station and rotating so as to cut partially with the laser beam into the workpiece with each rotation until the workpiece is cut radially through and the end portion thereof is separated from the workpiece.

17. The method defined in claim 16, further comprising the step of:
engaging a nozzle into each workpiece when same is stopped in the work station and
blowing a gas into each workpiece from the nozzle such that particles generated by the cutting operation are blown out of the workpiece.

18. The method defined in claim 17, wherein the work station is provided with an axial end stop and each workpiece has a closed inner end opposite an open outer end from which the end portion is to be cut, the method further comprising the step of:
pressing the closed inner end of each of the workpieces against the end stop when stopped in the work station with the gas blown in from the nozzle.

19. An apparatus for carrying out the method of claim 1.
